(19) United States
(12) Patent Application Publication
(10) Pub. No.: US 2010/0319902 A1
(43) Pub. Date: Dec. 23, 2010

(54) AUXILIARY APPARATUS FOR VEHICLE WATER TANK

(76) Inventor: Wan Ching Chou, Taiwan (TW)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/640,294

(22) Filed: Dec. 17, 2009

(30) Foreign Application Priority Data
Jun. 19, 2009 (TW) 098120750
Oct. 21, 2009 (TW) 098219435

(51) Int. Cl. G05D 16/00

(52) U.S. Cl. 165/281

(57) ABSTRACT

An auxiliary apparatus for a vehicle water tank is applicable to a cooling system. The auxiliary apparatus includes a water supply apparatus, a pressure relief apparatus, a state sensor, and a controller. The water supply apparatus has a feed-water pump and an auxiliary water tank. The cooling system and the auxiliary water tank respectively accommodate a cooling fluid. The pressure relief apparatus detects a pressure in the cooling system, and guides the cooling fluid in the cooling system to the auxiliary water tank when the pressure exceeds a predetermined pressure value. The state sensor detects a storage state of the cooling fluid in the cooling system. The controller stops the feed-water pump according to the storage state sensed by the state sensor, or starts the feed-water pump to guide the cooling fluid in the auxiliary water tank to the cooling system.

### CROSS-REFERENCE TO RELATED APPLICATIONS

This non-provisional application claims priority under 35 U.S.C. §119(a) on Patent Application No(s). 098120750 and 098219435 filed in Taiwan, R.O.C. on Jun. 19, 2009 and Oct. 21, 2009, the entire contents of which are hereby incorporated by reference.

### BACKGROUND OF THE INVENTION

1. Field of the Invention

The present invention relates to an auxiliary apparatus for a vehicle water tank, and more particularly to an automatic feed-water and anti-burst auxiliary apparatus for a vehicle water tank.

2. Related Art

A cooling system for a vehicle engine is used to dissipate the heat generated due to the combustion of the engine, so as to maintain the engine in a normal operating temperature range. According to different cooling manners, the engines may be classified into air-cooled engines and water-cooled engines, in which the water-cooled engines are cooled through the circulation of cooling water in the engine.

The cooling circulation of the water-cooled engine may be divided into a small circulation and a large circulation. The small circulation refers to the circulation of the cooling water merely within the engine, and the large circulation refers to the circulation of the cooling water between the engine and a heat exchanger (water tank). The temperature of the engine is low in a cold vehicle state, and in this case, a small amount of cooling water performs the small circulation in the engine, so as to enable the engine to reach an operating temperature quickly. Once the engine reaches the operating temperature, a temperature control valve (a so-called thermostat, which is recently not used in some vehicles) for controlling a conversion between the large and the small circulations is opened, and meanwhile, a water pump forces the cooling water to flow to the water tank, so as to dissipate the heat through a heat exchange between the water tank and the external air, in which the higher the temperature of the engine is, the larger the opening degree of the thermostat will be, and the flow of the cooling water is increased accordingly to dissipate more heat. Since the circulation of the cooling water is enabled by the water pump and the water pump is driven by the operation of the engine, the operating speed of the water pump rises with the increase of the rotation speed of the engine.

However, the aforementioned water cooling system still has the following problems in actual applications. Firstly, when the water tank is overheated, a pressure relief may occur to the cover of the water tank, and during the pressure relief, the water or water vapor in the water tank is collected by a subsidiary water tank, so that the water in the water tank is decreasing, and the cooling effect of the system is getting worse. Meanwhile, the water collected in the subsidiary water tank may not return to the water tank until the temperature of the water tank resumes to the cold vehicle state. Secondly, the water temperature of the water tank depends on the vehicle operating state, the vehicle size, and the load. As the pressure in the water tank rises with the increase of the water temperature, when the pressure gets excessively high and the pressure relief fails to be carried out, the water tank may be burst. Thirdly, in some cases, the water tank leaks due to damages resulting from aging or other causes, and after a long-time use, the water tank becomes overheated or the cooling water is insufficient.

In addition to the existing hardware problems in the cooling system of the vehicle water tank, the users also propose improvements to the current cooling system.

1. As most of the users do not have the capability of examining and repairing the vehicle, when the engine is overheated, the users do not know what to do.

2. The cooling water in the water tank may generate water scales, and the water scales may block a pressure relief hole (also referred to as a pressure discharge hole). Thereby, the pressure is greatly increased, and the cooling water fails to be drained, which may result in burst of the pipes or the water tank of the cooling system.

3. The water tank may be plasticized, and the pressure-resisting capability of the water tank is deteriorated.

4. When driving on an express highway, it is rather dangerous if the user cannot stop to cope with the situation immediately after finding that the amount of water in the engine is insufficient.

5. When the vehicle is in motion, foreign substances may bump into the water tank, and even damage the water tank to cause leakage, which may result in circulation disorder of the cooling water.

6. When driving the vehicle, most of the drivers concentrate on the driving, but not always keep an eye on the variation of the water temperature, so that if the cooling circulation goes abnormal, the engine may be burnt out after a long-time use.

7. When the temperature of the water tank is excessively high, even if the cooling water flows to the subsidiary water tank, as the water tank and the subsidiary water tank are communicated with each other, the pressure between the two is equivalent. Thereby, when the pressure in the water tank is excessively high, the part of the water tank or the subsidiary water tank having the weakest structural strength may be burst, which is quite dangerous.

### SUMMARY OF THE INVENTION

In view of the above, the present invention is an auxiliary apparatus for a vehicle water tank, which is capable of supplying and adjusting a water level and/or a water amount of the vehicle water tank in real time as required in the prior art.

In order to achieve the above objective, the present invention provides an auxiliary apparatus for a vehicle water tank, which is applicable to a cooling system accommodating a cooling fluid. The auxiliary apparatus comprises a water supply apparatus, a pressure relief apparatus, a state sensor, and a controller. The water supply apparatus has a feed-water pump and an auxiliary water tank accommodating the cooling fluid. The pressure relief apparatus, having a first predetermined pressure value, is correspondingly disposed in the cooling system and connected to the auxiliary water tank, for detecting a pressure in the cooling system and guiding the cooling fluid in the cooling system to the auxiliary water tank when the pressure exceeds the first predetermined pressure value. The state sensor is correspondingly disposed in the cooling system, for detecting a storage state of the cooling fluid in the cooling system. The controller is correspondingly disposed in the cooling system and respectively connected to the water supply apparatus, the pressure relief apparatus, and the state sensor, for selectively starting the feed-water pump to guide the cooling fluid in the auxiliary water tank to the cooling system or stopping the feed-water pump.

By using the auxiliary apparatus for the vehicle water tank, when the temperature in the cooling system rises, the water in the cooling system is vaporized, so that the water amount in the cooling system is reduced, and the pressure in the cooling system goes up. At this time, under the effect of the pressure relief valve, the water vapor flows into the auxiliary water tank after the pressure relief, so that the water level (or the pressure) in the cooling system is lowered, the state sensor transmits the sensed storage state in the cooling system to the controller, and the controller controls the feed-water pump to supply the water stored in the auxiliary water tank to the cooling system.

### BRIEF DESCRIPTION OF THE DRAWINGS

The present invention will become more fully understood from the detailed description given herein below for illustration only, and thus are not limitative of the present invention, and wherein:

FIG. 1 is a schematic view of an auxiliary apparatus for a vehicle water tank according to a first embodiment of the present invention;

FIG. 2 is a schematic view illustrating that the auxiliary water tank supplies water to a cooling system when the amount of water in the vehicle cooling system is reduced according to the first embodiment of the present invention;

FIG. 3 is a schematic view illustrating that a pressure relief valve operates to guide a cooling fluid at a high temperature in the cooling system to the auxiliary water tank when a pressure in the vehicle cooling system exceeds a predetermined pressure value according to the first embodiment of the present invention;

FIG. 4 is a schematic view of an auxiliary apparatus for a vehicle water tank according to a second embodiment of the present invention;

FIG. 5 is a schematic view illustrating that the auxiliary water tank supplies water to a cooling system when the amount of water in the vehicle cooling system is reduced according to the second embodiment of the present invention; and

FIG. 6 is a schematic view illustrating that a pressure relief valve operates to guide a cooling fluid at a high temperature in the cooling system to the auxiliary water tank when a pressure in the vehicle cooling system exceeds a predetermined pressure value according to the second embodiment of the present invention.

### DETAILED DESCRIPTION OF THE INVENTION

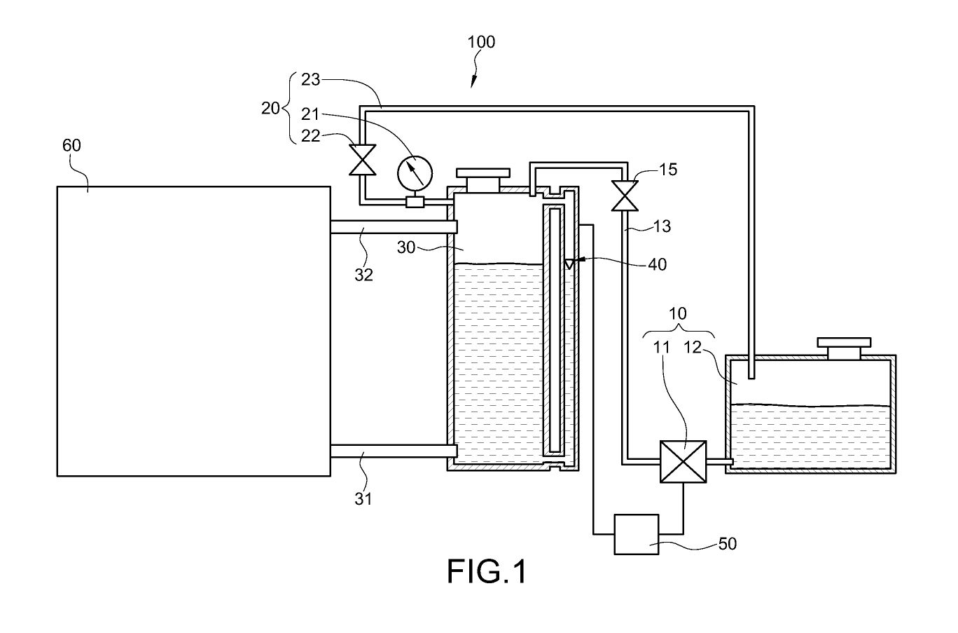

Referring to FIG. 1, an auxiliary apparatus for a vehicle water tank 100 according to a first embodiment of the present invention comprises a water supply apparatus 10, a pressure relief apparatus 20, a cooling system 30, a state sensor 40, a controller 50, and an engine 60. The auxiliary apparatus is applicable to a vehicle cooling system (which is merely represented by a cooling water tank herein, but the present invention is not limited thereto). The vehicle may be a common car, a wagon, a heavy motor, a machine shop car, or the like. The vehicles having the water tank and adopting the water-cooled manner all fall within the application field of the auxiliary apparatus of the present invention.

The water supply apparatus 10 comprises a feed-water pump 11 and an auxiliary water tank 12. The auxiliary water tank 12 has an appropriate accommodation space for accommodating a cooling fluid. The cooling system also accommodates the cooling fluid. The cooling fluid accommodated in the auxiliary water tank and the cooling system may be common cooling water or cooling water doped with a coolant.

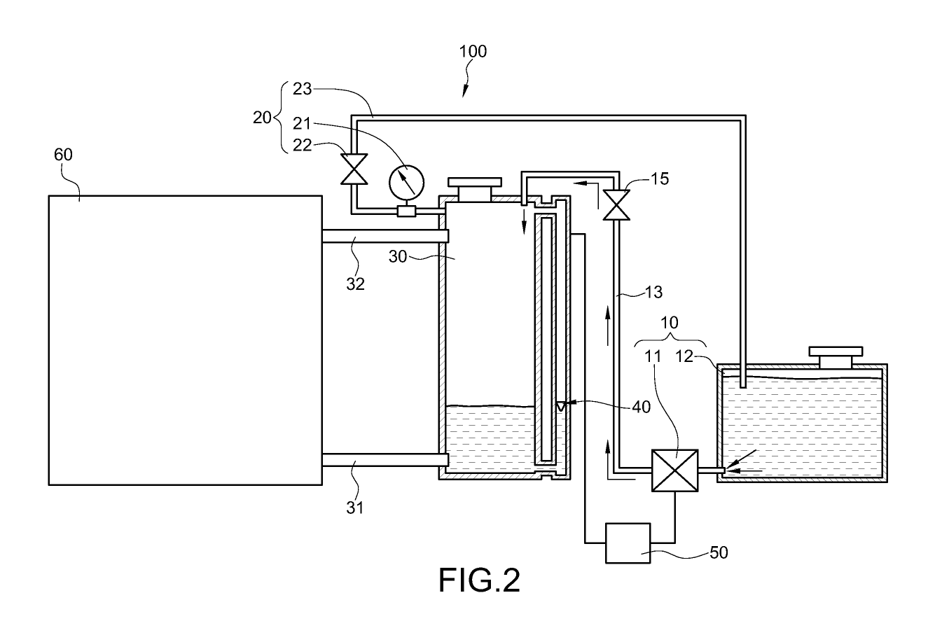

Referring to FIG. 2, the auxiliary water tank 12 has a water pipe 13 and a valve body 15, and the valve body 15 is disposed in the water pipe 13 for turning on or off the water pipe 13. That is to say, when the valve body 15 is opened, the fluid in the water pipe 13 is flowing, and on the contrary, when the valve body 15 is closed, the fluid on two ends of the water pipe 13 cannot communicate with each other. The water pipe 13 is connected to an input end of the cooling system 30. When the feed-water pump 11 is started, the valve body 15 is also opened, and in this case, the feed-water pump 11 pumps the cooling fluid in the auxiliary water tank 12 to the cooling system 30 through the water pipe 13, so that the cooling fluid at a low temperature in the auxiliary water tank 12 flows to the accommodation space in the cooling system 30.

The pressure relief apparatus 20 comprises a pressure gauge 21, a pressure relief valve 22, and a pressure relief pipe 23. The pressure gauge 21 is connected to the pressure relief valve 22 and the cooling system 30. The pressure gauge 21 is placed on the cooling system 30, for sensing a pressure value in the cooling system 30, and the pressure gauge 21 is set with a first predetermined pressure value.

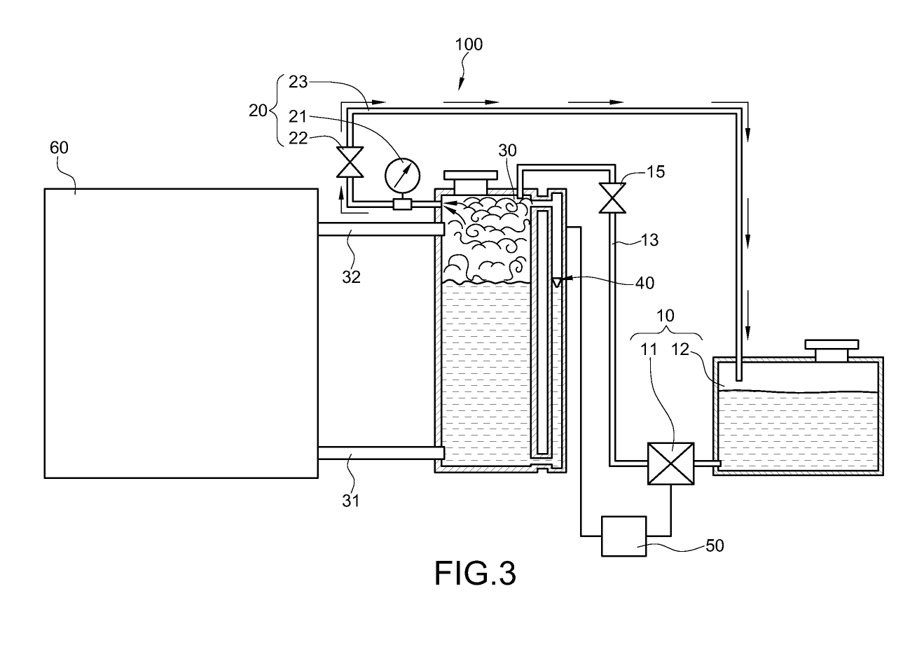

Referring to FIG. 3, when the pressure in the cooling system 30 exceeds the first predetermined pressure value, the pressure relief valve 22 operates to guide the cooling fluid at a high temperature in the cooling system 30 to the auxiliary water tank 12. The pressure relief valve 22 may be a mechanical pressure relief valve or an electronic pressure relief valve. The mechanical pressure relief valve is formed by a spring and a pressure relief cover, and operates when the pressure gets excessively high and pulls the spring. The electronic pressure relief valve operates under the control of a pressure relief controller.

The pressure relief pipe 23 is connected to an output end of the cooling system 30, for guiding the cooling fluid at a high temperature in the cooling system 30 to flow back to the accommodation space in the auxiliary water tank 12.

The cooling system 30 is connected to the engine 60 to maintain the engine 60 in an appropriate temperature. The cooling fluid at a low temperature is output from an outlet pipe 31 at a bottom portion of the cooling system 30 to a low-temperature pipeline of the engine 60, and the cooling fluid at a high temperature discharged from a high-temperature pipeline of the engine 60 is input through an inlet pipe 32 at a top portion of the cooling system 30.

In this embodiment, the state sensor 40 is a water level gauge installed on the cooling system 30, for sensing a water level in the cooling system 30. The state sensor 40 has a first predetermined value and a second predetermined value. When the liquid level of the cooling fluid is lower than the first predetermined value, the controller 50 starts the feed-water pump 11. When the liquid level of the cooling fluid is higher than the second predetermined value, the controller 50 stops the feed-water pump 11. Although the state sensor 40 shown in the figures of the present invention adopts the communicating pipe principle, the present invention is not limited thereto, and the water level gauges commonly seen in the market may also be used.

The controller 50 is connected to the state sensor 40, the pressure relief valve 22, and the feed-water pump 11. When the pressure in the cooling system 30 rises, the controller 50 needs to control the pressure relief valve 22 to operate first. The decision of performing the pressure relief may be made by the pressure relief apparatus 20 on its own or under the control of the controller 50.

Based on the above structure, in this embodiment, the pressure gauge 21 transmits a signal of the sensed pressure in the cooling system 30 to the controller 50 in real time. Then, the controller 50 controls the pressure relief valve 22 to operate according to the pressure value sensed by the pressure gauge 21, so as to achieve an anti-burst effect of the auxiliary apparatus for the vehicle water tank 100. In addition, after the automatic pressure relief, the pressure in the cooling system 30 is reduced, and the controller 50 starts the feed-water pump 11 to automatically feed water, so that the driver does not need to get down to feed the water. By using the auxiliary apparatus of this embodiment, the anti-burst and the automatic feed-water objectives are realized through the feed-water pump 11, the controller 50, the state sensor 40, the pressure gauge 21, and the pressure relief valve 22.

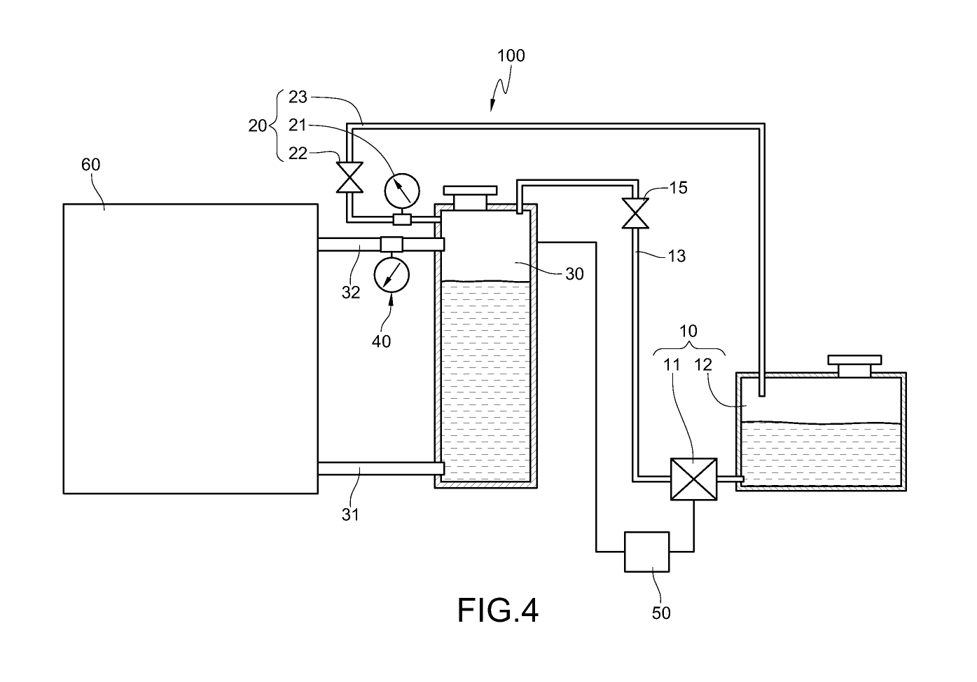

FIG. 4 is a schematic view of an auxiliary apparatus for a vehicle water tank according to a second embodiment of the present invention. The second embodiment and the first embodiment of the present invention are approximately the same in structure, and the differences between the two are described in the following.

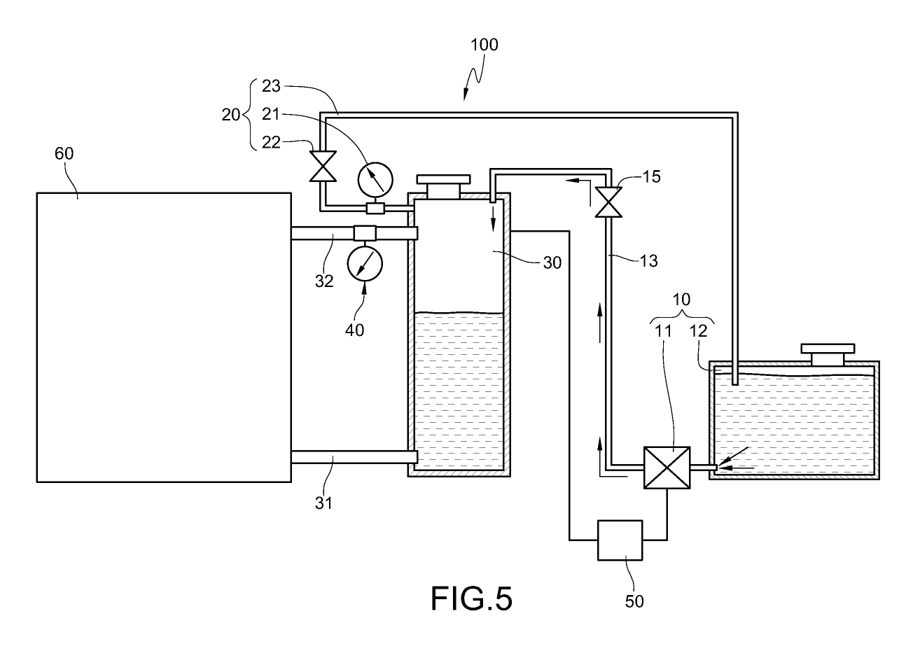

Referring to FIGS. 4 to 6, the auxiliary apparatus for the vehicle water tank 100 according to the second embodiment of the present invention comprises a water supply apparatus 10, a pressure relief apparatus 20, a cooling system 30, a state sensor 40, a controller 50, and an engine 60. The auxiliary apparatus is applicable to a vehicle cooling system (which is merely represented by a cooling water tank herein, but the present invention is not limited thereto). The state sensor 40 is a pressure detection apparatus, and in this embodiment, the state sensor 40 is in a form of a pressure gauge for illustration only instead of limiting the present invention. The state sensor 40 is installed on an inlet pipe 32 of the cooling system 30, for sensing a pressure in the cooling system 30, and the state sensor 40 is set with a second predetermined pressure value. The second predetermined pressure value is smaller than or equal to the first predetermined pressure value. When the pressure in the cooling system 30 is smaller than the second predetermined pressure value, the state sensor 40 transmits a signal of the sensed pressure in the cooling system 30 to the controller 50 in real time. Thereby, the controller 50 starts the feed-water pump 11 to guide the cooling fluid in the auxiliary water tank 12 to the cooling system 30 (as shown in FIG. 5).

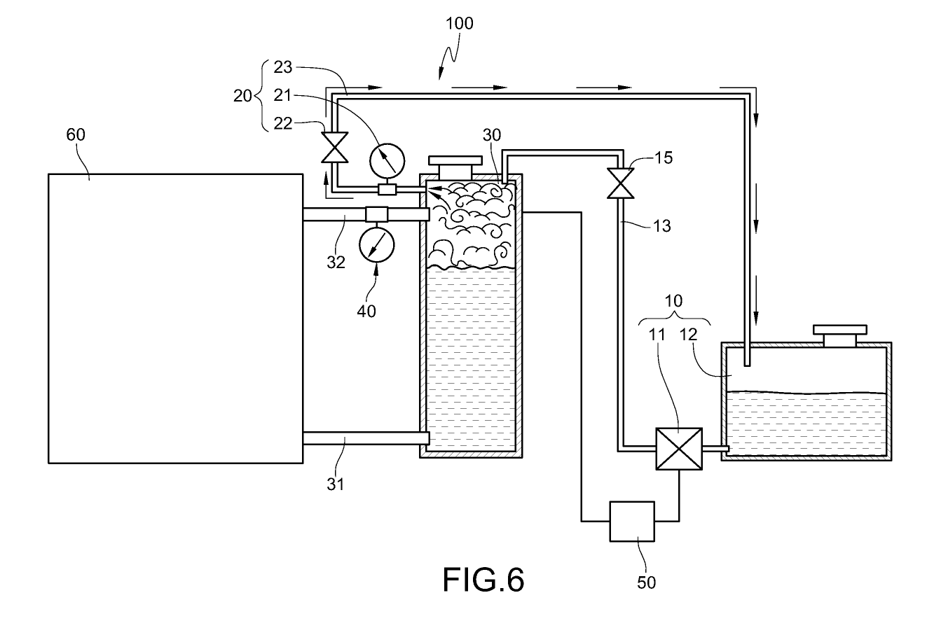

The controller 50 is respectively connected to the state sensor 40, the pressure relief apparatus 20, and the feed-water pump 11. The controller 50 normally starts the feed-water pump 11 for feeding the cooling fluid in the auxiliary water tank 12 to the cooling system 30, so as to maintain the pressure in the cooling system 30 normally at the second predetermined pressure value. Further, when the state sensor 40 detects that the pressure in the cooling system 30 reaches the second predetermined pressure value, the controller 50 stops the feed-water pump 11. In addition, when the pressure in the cooling system 30 rises, the controller 50 controls the pressure relief valve 22 to operate (as shown in FIG. 6). The decision of performing the pressure relief may be made by the pressure relief apparatus 20 on its own or under the control of the controller 50.

Based on the above structure, in this embodiment, the controller 50 normally starts the feed-water pump 11 in a cold vehicle state or when the pressure in the cooling system 30 is lower than the second predetermined pressure value, so that the cooling fluid in the auxiliary water tank 12 is delivered to the cooling system 30 through the water pipe 13. Meanwhile, the state sensor 40 detects the pressure in the cooling system 30, and transmits the sensed pressure value to the controller 50. When the pressure in the cooling system reaches the second predetermined pressure value, the controller 50 stops the feed-water pump 11 and maintains the pressure in the cooling system 30 at the second predetermined pressure value. Through the functional design of the automatic feed-water, a certain amount of cooling fluid can be normally maintained in the cooling system 30 with no need for the driver to get down to feed the water.

Moreover, as the cooling system 30 has a sufficient amount of the cooling fluid in the cold vehicle state, when the vehicle enters a vehicle warm-up state from the cold vehicle state, the cooling system may provide the sufficient cooling fluid to the engine for performing the circulation in real time, thereby improving the operating efficiency of the engine and greatly enhancing the heat dissipation effect.

Next, in the vehicle warm-up state, the pressure gauge 21 of the pressure relief apparatus 20 transmits the signal of the sensed pressure in the cooling system 30 to the controller 50 in real time. Then, the controller 50 controls the pressure relief valve 22 to operate according to the pressure value sensed by the pressure gauge 21, so as to achieve an anti-burst effect of the auxiliary apparatus for the vehicle water tank 100. By using the auxiliary apparatus of this embodiment, the anti-burst and the automatic feed-water objectives are realized through the feed-water pump 11, the controller 50, the state sensor 40, the pressure gauge 21, and the pressure relief valve 22.

Through the above structure, the auxiliary apparatus for the vehicle water tank 100 achieves the anti-burst and the automatic feed-water objectives. In the following two circumstances, the procedures of achieving the anti-burst and the automatic feed-water objectives during the operation of the cooling system are illustrated with actual tests of the vehicle cooling system.

In a first test, the inventor simulates the circumstance that the cover of the water tank is damaged and the cooling system cannot carry out the pressure relief, so that the pressure in the cooling system becomes excessively high after a long time of driving. In this case, if the auxiliary apparatus for the vehicle water tank of the present invention is installed, during the trip from Kaohsiung to Taipei, the water tank is prevented from bursting by using the pressure relief apparatus of the present invention, thereby ensuring the safety of the driver and the passengers.

In a second test, the inventor simulates the circumstance that the water tank is damaged or burst and the cooling system begins to leak, so that the operating temperature of the engine becomes excessively high to cause abnormal flame-out of the engine and pose a great danger to the driver and the passengers. In this case, if the auxiliary apparatus for the vehicle water tank of the present invention is installed, during the trip from Kaohsiung to Taipei, by using the auxiliary apparatus of the present invention, the auxiliary water tank can feed the same amount of water to the cooling system depending on the leakage of the water tank per second, thereby realizing the automatic feed-water effect and ensuring the safety of the driver and the passengers.

What is claimed is:

1. An auxiliary apparatus for a vehicle water tank, applicable to a cooling system accommodating a cooling fluid, the auxiliary apparatus comprising:
a water supply apparatus, having a feed-water pump and an auxiliary water tank accommodating the cooling fluid;
a pressure relief apparatus, having a first predetermined pressure value, correspondingly disposed in the cooling system, and connected to the auxiliary water tank, for detecting a pressure in the cooling system, and guiding the cooling fluid in the cooling system to the auxiliary water tank when the pressure exceeds the first predetermined pressure value;
a state sensor, correspondingly disposed in the cooling system, for detecting a storage state of the cooling fluid in the cooling system; and
a controller, correspondingly disposed in the cooling system and respectively connected to the water supply apparatus, the pressure relief apparatus, and the state sensor, for selectively starting the feed-water pump to guide the cooling fluid in the auxiliary water tank to the cooling system or stopping the feed-water pump according to the storage state sensed by the state sensor.

2. The auxiliary apparatus for the vehicle water tank according to claim 1, wherein the state sensor is a water level gauge for detecting a liquid level of the cooling fluid in the cooling system, the water level gauge has a first predetermined value and a second predetermined value, when the liquid level is lower than the first predetermined value, the controller starts the feed-water pump, and when the liquid level is higher than the second predetermined value, the controller stops the feed-water pump.

3. The auxiliary apparatus for the vehicle water tank according to claim 1, wherein the state sensor is a pressure detection apparatus for detecting the pressure in the cooling system, the pressure detection apparatus has a second predetermined pressure value, when the second predetermined pressure value is lower than the pressure in the cooling system, the controller normally starts the feed-water pump, and when the pressure in the cooling system reaches the second predetermined pressure value, the controller stops the feed-water pump.

4. The auxiliary apparatus for the vehicle water tank according to claim 1, wherein the pressure relief apparatus comprises a pressure gauge, a pressure relief valve, and a pressure relief pipe, the pressure relief pipe is connected to the cooling system and the auxiliary water tank, the pressure relief valve is disposed in the pressure relief pipe, and the pressure gauge is used for detecting the pressure in the cooling system, when the pressure in the cooling system exceeds the first predetermined pressure value, the pressure relief valve is started to guide the cooling fluid in the cooling system to the auxiliary water tank.

5. The auxiliary apparatus for the vehicle water tank according to claim 1, wherein the water supply apparatus further comprises a water pipe and a valve body, the valve body is disposed in the water pipe for turning on or off the water pipe, the water pipe is connected to the auxiliary water tank, the feed-water pump, and the cooling system, and when the feed-water pump is started, the feed-water pump guides the cooling fluid in the auxiliary water tank to the cooling system through the water pipe and the valve body.
